(19) United States
(12) Patent Application Publication
(10) Pub. No.: US 2012/0140489 A1
(43) Pub. Date: Jun. 7, 2012

(54) Illumination Device with a Lamp Cap Capable of Dissipating Heat and Spreading Light

(76) Inventors: Devin Chung, Tainan City (TW); Tsung-Yi Lan, Kaohsiung City (TW); Chia-Ho Chen, Kaohsiung City (TW)

(21) Appl. No.: 13/218,883

(22) Filed: Aug. 26, 2011

(30) Foreign Application Priority Data
Dec. 2, 2010 (TW) 099223397

(51) Int. Cl. F21V 21/02

(52) U.S. Cl. 362/368

(57) ABSTRACT

An illumination device includes: a mounting unit; a lighting unit including a circuit board mounted on the mounting unit, and at least one light emitting component mounted on the circuit board; and a lamp cap mounted on the mounting unit for covering the lighting unit. The lamp cap includes a surrounding wall disposed around the lighting unit, a central top wall disposed spacedly in the surrounding wall, and a plurality of spaced apart connecting ribs interconnecting the surrounding wall and the central top wall such that a plurality of vent holes are formed among the surrounding wall, the central top wall and the connecting ribs.

### CROSS-REFERENCE TO RELATED APPLICATION

This application claims priority to Taiwanese Application No. 099223397, filed on Dec. 2, 2010.

### BACKGROUND OF THE INVENTION

1. Field of the Invention

The invention relates to an illumination device, and more particularly to an illumination device with a lamp cap capable of dissipating heat and spreading light.

2. Description of the Related Art

FIG. 1 illustrates a conventional illumination device 1 that includes a heat dissipating base 11, a lighting unit 12, and a light-transmissive lamp cap 13. The heat-dissipating base 11 includes a mounting wall 111, a surrounding wall 112 extending upward from a periphery of the mounting wall 111, and a plurality of metallic heat-dissipating fins 113 extending downward from the mounting wall 111. The lighting unit 12 includes a circuit board 121 mounted on the mounting wall 111 of the heat-dissipating base 11, and a plurality of light emitting diodes 122 mounted on the circuit board 121. The lamp cap 13 has an open end 131 connected threadedly to the surrounding wall 112 of the heat dissipating base 11 so as to cover sealingly the lighting unit 12.

In use, heat generated by the lighting unit 12 is merely dissipated by the metallic heat-dissipating fins 113. However, due to the presence of the metallic heat-dissipating fins 113, the conventional illumination device 1 has relatively high costs. Improvements may be made to the conventional illumination device 1.

### SUMMARY OF THE INVENTION

Therefore, an object of the present invention is to provide an illumination device with a lamp cap that can effectively dissipate heat and spread light.

According to one aspect of the present invention, an illumination device comprises:

a mounting unit;

a lighting unit including a circuit board mounted on the mounting unit, and at least one light emitting component disposed on the circuit board; and

a lamp cap mounted on the mounting unit for covering the lighting unit, the lamp cap including a surrounding wall disposed around the lighting unit, a central top wall disposed spacedly in the surrounding wall, and a plurality of spaced apart connecting ribs interconnecting the surrounding wall and the central top wall such that a plurality of vent holes are formed among the surrounding wall, the central top wall and the connecting ribs.

According to another aspect of the present invention, there is provided a lamp cap adapted to be mounted on a mounting unit for covering a lighting unit on the mounting unit. The lamp cap comprises:

a surrounding wall adapted to be disposed around the lighting unit;

a central top wall disposed spacedly in the surrounding wall; and

a plurality of spaced apart connecting ribs interconnecting the surrounding wall and the central top wall such that a plurality of vent holes are formed among the surrounding wall, the central top wall and the connecting ribs.

### BRIEF DESCRIPTION OF THE DRAWINGS

Other features and advantages of the present invention will become apparent in the following detailed description of the preferred embodiments with reference to the accompanying drawings, of which:

FIG. 1 is a partially exploded perspective view of a conventional illumination device;

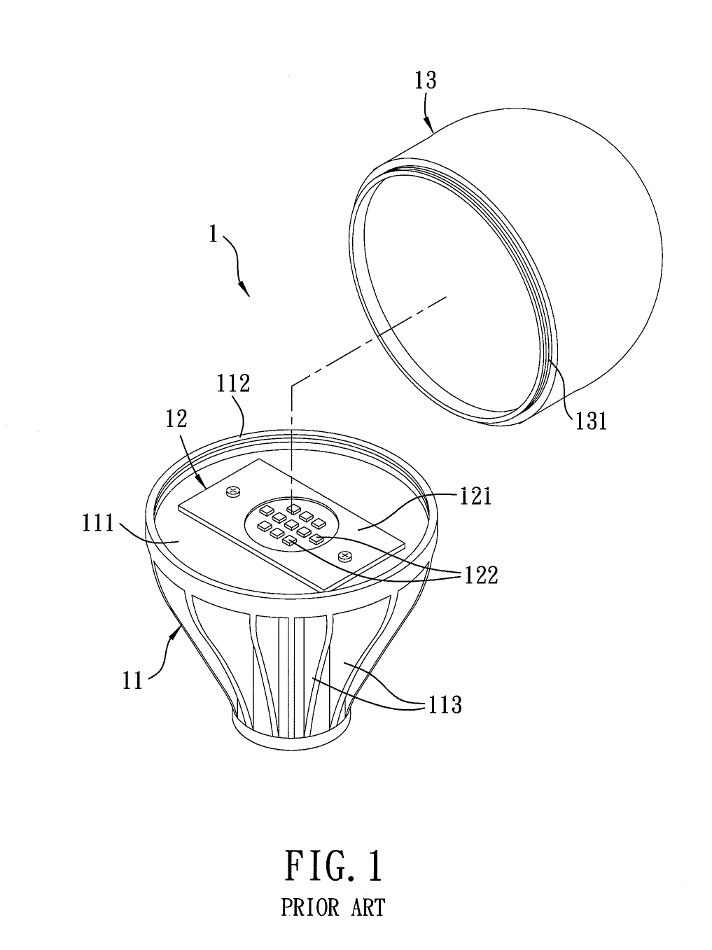

FIG. 2 is a partially schematic sectional view of the conventional illumination device;

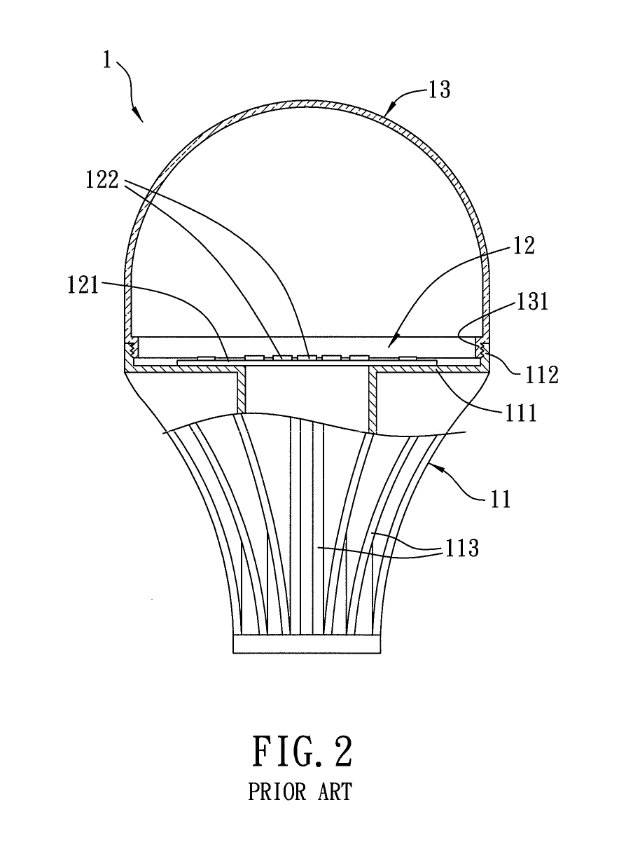

FIG. 3 is an exploded perspective view showing the first preferred embodiment of an illumination device according to the present invention;

FIG. 4 is a schematic sectional view showing the first preferred embodiment;

FIG. 5 is an exploded perspective view showing the second preferred embodiment of an illumination device according to the present invention;

FIG. 6 is a schematic sectional view showing the second preferred embodiment; and

FIG. 7 is a schematic sectional view showing the third preferred embodiment of an illumination device according to the present invention.

### DETAILED DESCRIPTION OF THE PREFERRED EMBODIMENTS

Before the present invention is described in greater detail, it should be noted that like elements are denoted by the same reference numerals throughout the disclosure.

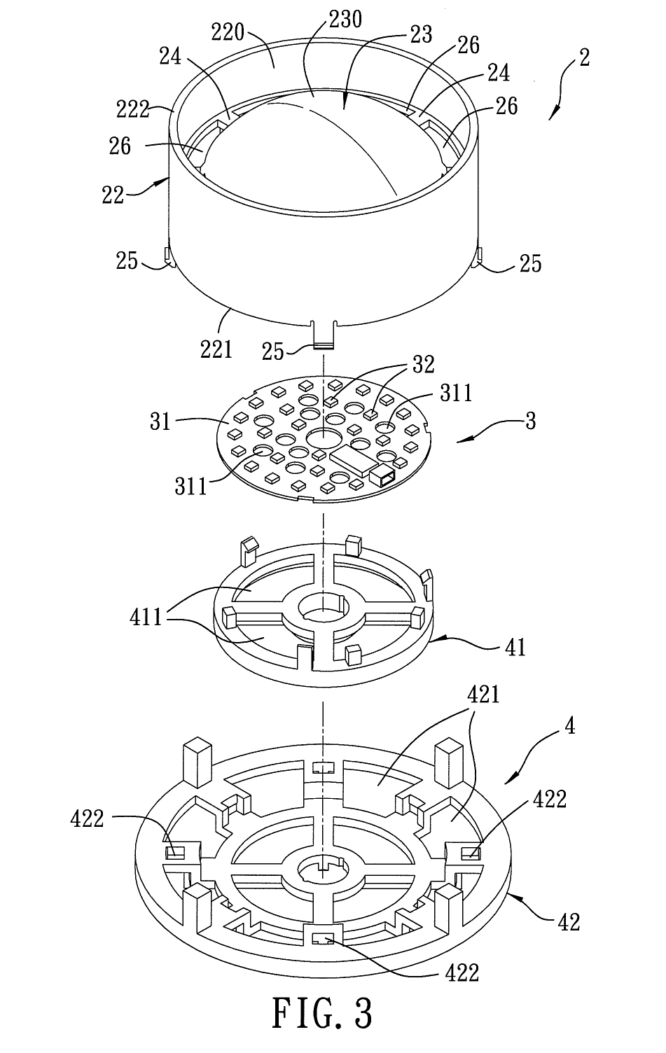

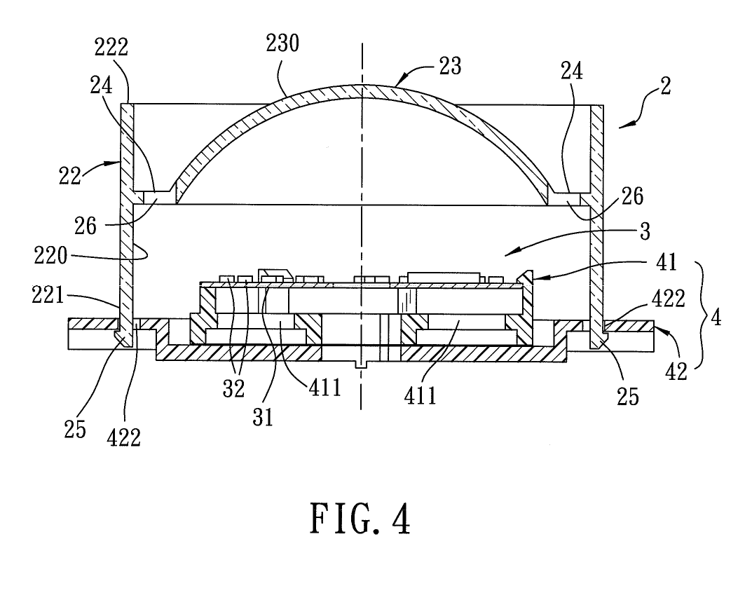

Referring to FIGS. 3 and 4, the first preferred embodiment of an illumination device according to the present invention is shown to include a mounting unit 4, a lighting unit 3, and a lamp cap 2.

In this embodiment, the mounting unit 4 includes a first mounting seat 41, and a second mounting seat 42. The second mounting seat 41 is mounted coaxially in the second mounting seat 42. The first mounting seat 41 is formed with a plurality of through holes 411 that extend in an axial direction. The second mounting seat 42 is formed with a plurality of through holes 421 that extends in the axial direction, and a plurality of engaging holes 422. In this embodiment, the engaging holes 422 are formed in a top side of the second mounting seat 42.

The lighting unit 3 includes a circuit board 31 mounted coaxially on the first mounting seat 41, and a plurality of light emitting components 32, such as light emitting diodes, disposed on the circuit board 31. As a result, an assembly of the first mounting seat 41 and the lighting unit 3 is mounted in the second mounting seat 42. The circuit board 31 is formed with a plurality of through holes 311 that extend in the axial direction.

The lamp cap 2 is mounted on the mounting unit 4 for covering the lighting unit 3. The lamp cap 2 is made of a light-transmissive material, and includes a surrounding wall 22, a central top wall 23, a plurality of spaced apart connecting ribs 24, and a plurality of engaging lugs 25. The surrounding wall 22 has opposite bottom and top ends 221, 222, and an inner annular surface 220. The engaging lugs 25 extend downward from the bottom end 221 of the surrounding wall 22 and engage respectively the engaging holes 422 in the second mounting seat 42 of the mounting unit 4. The central top wall 23 is curved and has a convex outer surface 230. The connecting ribs 24 interconnect the surrounding wall 22 and the central top wall 23 such that a plurality of vent holes 26 are formed among the surrounding wall 22, the central top wall 23 and the connecting ribs 24. In this embodiment, each connecting rib 24 extends radially between the inner annular surface 220 of the surrounding wall 22 and a periphery of the central top wall 23.

In use, the central top wall 23 of the lamp cap 2 spreads light radiated from the light emitting components 32. In addition, heat generated by the lighting unit 3 can be effectively dissipated by airflow passing through the vent holes 24 in the lamp cap 2, through the through holes 311 in the circuit board 31, and through the through holes 411, 421 in the mounting unit 4.

The illumination device of the present invention can be implemented in an illumination appliance, such as a table lamp, a floor lamp, a wall lamp, a chandelier, a ceiling lamp, a corridor lamp or a bedside lamp.

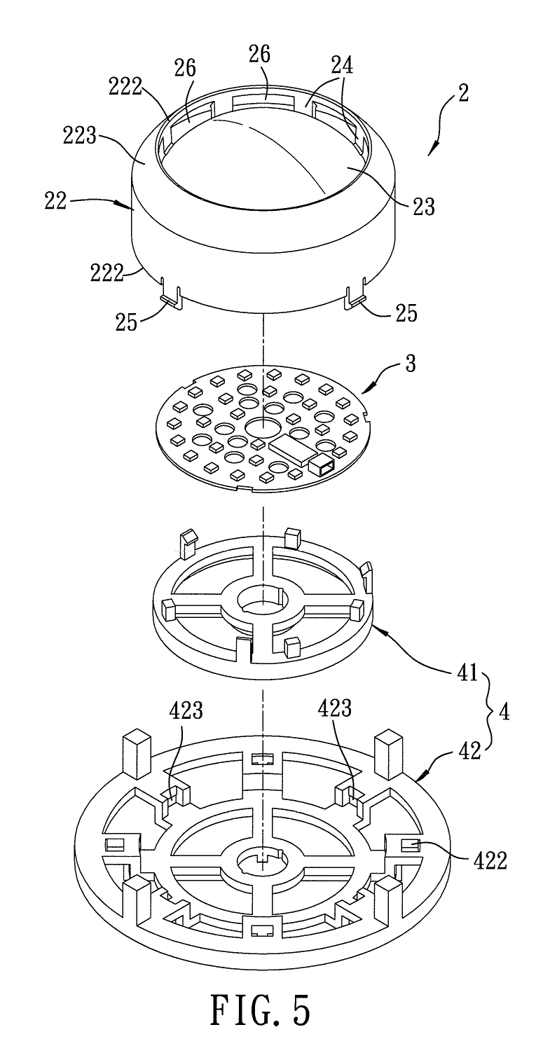

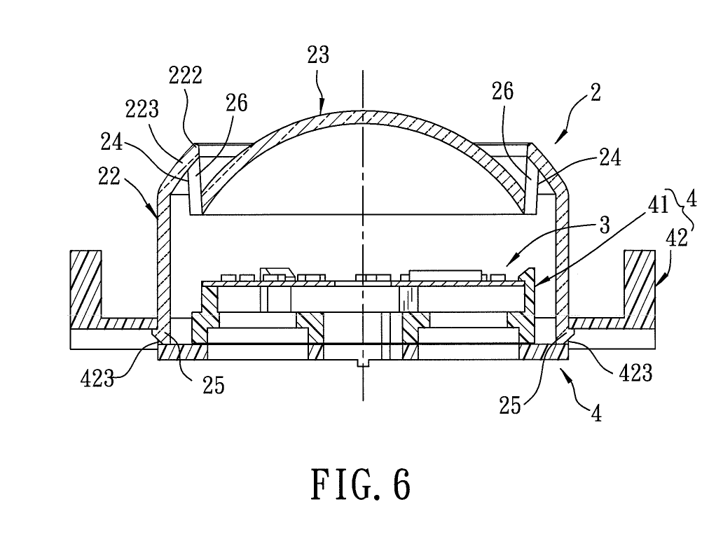

FIGS. 5 and 6 illustrate the second preferred embodiment of an illumination device according to this invention, which is a modification of the first preferred embodiment. In this embodiment, the surrounding wall 22 of the lamp cap 2 has an upward and inward extending upper wall portion 223 that has the top end 222. Each connecting rib 24 extends upward from the periphery of the central top wall 23 to the top end 222 of the upper wall portion 223 of the surrounding wall 22.

In addition, the second mounting seat 42 has an inner annular side formed with a plurality of engaging holes 423 that engage respectively the engaging lugs of the lamp cap 2.

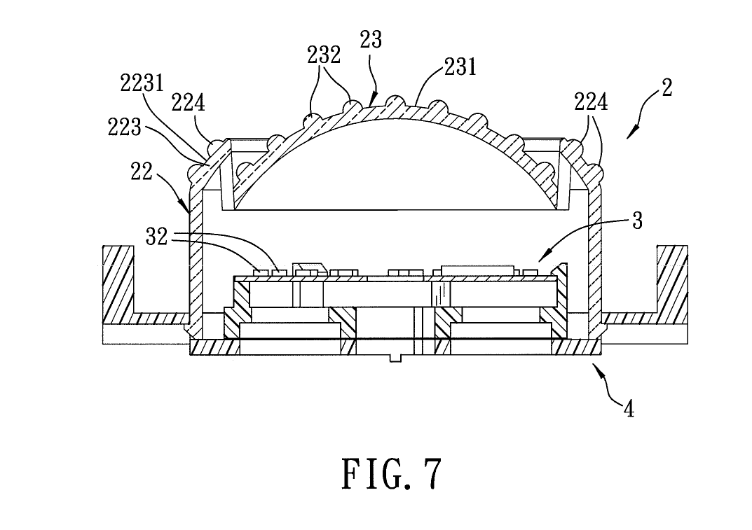

FIG. 7 illustrates the third preferred embodiment of an illumination device according to this invention, which is a modification of the second preferred embodiment. In this embodiment, the convex outer surface 231 of the central top wall 23 of the lamp cap 2 formed with a plurality of light-condensing protrusions 232. The upper wall portion 223 of the surrounding wall 22 of the lamp cap 2 has an outer surface 2231 formed with a plurality of light-condensing protrusions 224. The light-condensing protrusions 232 and 224 condense light irradiated from the light emitting components 32 of the lighting unit 3.

In sum, due to the presence of the vent holes 26 in the lamp cap 2, the through holes 311 in the circuit board 31 and the through holes 411, 421 in the mounting unit 4, heat generated by the lighting unit 3 can be effectively dissipated without metallic heat-dissipating fins. Therefore, the illumination device of the present invention has a relatively low cost.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An illumination device comprising:
a mounting unit;
a lighting unit including a circuit board mounted on said mounting unit, and at least one light emitting component disposed on said circuit board; and
a lamp cap mounted on said mounting unit for covering said lighting unit, said lamp cap including a surrounding wall disposed around said lighting unit, a central top wall disposed spacedly in said surrounding wall, and a plurality of spaced apart connecting ribs interconnecting said surrounding wall and said central top wall such that a plurality of vent holes are formed among said surrounding wall, said central top wall and said connecting ribs.

2. The illumination device as claimed in claim 1, wherein said central top wall of said lamp cap is curved and has a convex outer surface.

3. The illumination device as claimed in claim 2, wherein said convex outer surface of said central top wall of said lamp cap is formed with a plurality of light-condensing protrusions.

4. The illumination device as claimed in claim 1, wherein said surrounding wall of said lamp cap has an inner annular surface, each of said connecting ribs of said lamp cap extending radially between said inner annular surface of said surrounding wall and a periphery of said central top wall.

5. The illumination device as claimed in claim 1, wherein said surrounding wall of said lamp cap has an upward and inward extending upper wall portion that has a top end, each of said connecting ribs of said lamp cap extending upward from a periphery of said central top wall to said top end of said upper wall portion of said surrounding wall.

6. The illumination device as claimed in claim 5, wherein said upper wall portion of said surrounding wall of said lamp cap has an outer surface formed with a plurality of light-condensing protrusions.

7. The illumination device as claimed in claim 1, wherein:
said mounting unit includes
a first mounting seat for mounting said lighting unit thereon, and
a second mounting seat for mounting an assembly of said lighting unit and said first mounting seat therein, said second mounting seat being formed with a plurality of engaging holes; and
said lamp cap further includes a plurality of engaging lugs extending downward from said surrounding wall and engaging respectively said engaging holes in said second mounting seat of said mounting unit.

8. The illumination device as claimed in claim 7, wherein each of said circuit board of said lighting unit, and said first and second mounting seats is formed with a plurality of through holes extending in an axial direction.

9. A lamp cap adapted to be mounted on a mounting unit for covering a lighting unit on the mounting unit, said lamp cap comprising:
a surrounding wall adapted to be disposed around the lighting unit;
a central top wall disposed spacedly in said surrounding wall; and
a plurality of spaced apart connecting ribs interconnecting said surrounding wall and said central top wall such that a plurality of vent holes are formed among said surrounding wall, said central top wall and said connecting ribs.

10. The lamp cap as claimed in claim 9, wherein said central top wall is curved and has a convex outer surface.

11. The lamp cap as claimed in claim 10, wherein said convex outer surface of said central top wall is formed with a plurality of light-condensing protrusions.

12. The lamp cap as claimed in claim 9, wherein:
said surrounding wall has an inner annular surface; and
each of said connecting ribs extends radially between said inner annular surface of said surrounding wall and a periphery of said central top wall.

13. The lamp cap as claimed in claim 9, wherein:
said surrounding wall has an upward and inward extending upper wall portion, said upper wall portion having a top end; and
each of said connecting ribs extends upward from a periphery of said central top wall to said top end of said upper wall portion of said surrounding wall.

14. The lamp cap as claimed in claim 13, wherein said upper wall portion of said surrounding wall has an outer surface formed with a plurality of light-condensing protrusions.
